(19) United States
(12) Patent Application Publication
(10) Pub. No.: US 2009/0173727 A1
(43) Pub. Date: Jul. 9, 2009

(54) Butt-joint Welding Method

(75) Inventors: Kwang Hee Yun, Gyeongsangnam-do (KR); Jin Yong Kim, Gyeongsangnam-do (KR); Tae Min Hong, Gyeongsangnam-do (KR)

Correspondence Address: HOFFMANN & BARON, LLP, 6900 JERICHO TURNPIKE, SYOSSET, NY, 11791, US

(73) Assignee: DAEWOO SHIPBUILDING & MARINE ENGINEERING CO., LTD., Seoul (KR)

(21) Appl. No.: 12/207,114

(22) Filed: Sep. 9, 2008

(30) Foreign Application Priority Data
Sep. 11, 2007 (KR) 10-2007-0092036
Oct. 19, 2007 (KR) 10-2007-0105493
Nov. 15, 2007 (KR) 10-2007-0116541

(51) Int. Cl. B23K 9/00

(52) U.S. Cl. 219/137 R

(57) ABSTRACT

A butt-joint welding method is disclosed, which is capable of improving welding productivity by reducing the number of welding passes by weaving a welding wire in submerged arc welding. The welding method includes arranging two parent metals having 10-35 mm thickness at an interval of 8-20 mm to face each other, attaching a backing material to rear sides of the two parent metals, the rear sides facing each other, so that the backing material seals a space between the parent metals through surface-contact with the rear sides, performing flux cored arc welding or compositely performing the flux cored arc welding and submerged arc welding 1-3 times on an upper layer of the backing material, and welding the two parent metals while weaving a submerged arc welding wire transversely.

### BACKGROUND OF THE INVENTION

1. Field of the Invention

The present invention relates to a butt-joint welding method, and more particularly to a butt-joint welding method, capable of improving welding productivity by reducing the number of welding passes by weaving a welding wire transversely in submerged arc welding (SAW).

2. Description of the Related Art

Generally, methods for welding two parent metals include a both-sides welding performing welding at both sides and a one-side welding performing welding at only one side. According to the both-sides welding, an initial welded layer of first side of the both sides is necessarily removed due to an inferior welding quality and, in addition, the parent metal or structure needs to be turned over after the one-side welding. Accordingly, not only being dangerous, the both-sides welding also requires enough height of the manufacture shop and takes much time for standing by the turnover and rearranging the parent metals. On the other hand, the one-side welding requires a working space to be ensured behind the parent metal because a backing material has to be attached and separated with a rear side of the parent metal before and after the welding so as to prevent a burn-through generated from the metal being welded. This accordingly demands relevant facilities. Furthermore, the operator may suffer from musculoskeletal disorders since having to perform attachment and separation of the backing material in an overhead position.

As described above, welding of two parent metals can be achieved by one-side welding or both-sides welding depending on the circumstances.

In constructing a vessel, a flux cored arc welding (FCAW) method and a submerged arc welding (SAW) method are generally used. More specifically, the FCAW method and the SAW method are solely or jointly applied for the welding during construction of a vessel. Since a welding heat input of the FCAW method is relatively low, the FCAW method is applied to the initial welding of the one-side welding in which possibility of a burn-through is high, to thereby prevent the burn-through. Afterwards, the FCAW or the SAW is additionally performed, thereby completing the welding.

When an interval between the two parent metals to be welded, that is, a root gap is 8-20 mm, the one-side welding is performed. That is, a backing material is attached to rear sides of the parent metals facing each other, and the FCAW having the low welding heat input is performed once or twice. Then, the overall welding is completed by performing the SAW having a high deposition rate. The FCAW applied to above the backing material is performed once or twice with a welding current of under 250 A. When performing the SAW adopting a welding wire having 4.8 mm diameter, a penetration depth is great if the welding current is greater than 600 A, thereby causing a burn-through penetrating an FCAW-welded portion on the backing material formed on the rear sides. Therefore, in order to prevent generation of the burn-through, the SAW performed on the FCAW-welded layer should be performed with a low current of under 600 A. Also, since a SAW-welded layer is thin as well, the SAW also needs to be performed with a low welding current so as to prevent the burn-through. Therefore, until completion of the overall welding, the SAW needs to be performed several times or even tens of times. In a case where the root gap between the parent metals is 4-12 mm, the overall welding can be completed by once or twice of the SAW by applying a supplemental wire which increases the deposition rate under the same welding current, a composite wire having a higher deposition rate than a solid wire under the same welding current, or combination of the supplemental wire and the composite wire. However, when the root gap is greater than 8 mm, just 2 mm of deviation of the welding wire from the center of the parent metal may incur lack of fusion (LF) at groove edges of the parent metal due to a fingerlike unique sectional shape of the welded portion, which occurs in the SAW.

When parent metals to be welded are as thick as 30-100 mm and arranged at a root gap of 0-10 m, the both-sides welding is employed for butt-joint welding having an X-shape or Y-shape groove while, on the other hand, the one-side welding is employed for butt-joint welding having a V-shape groove. For welding of the thick parent metal of about 30-100 mm thickness, the FCAW method and the SAW method can be solely or jointly employed.

FIG. 1 and FIG. 2 illustrate the welding processes of thick parent metals according to a conventional art.

Referring to FIG. 1, the both-sides welding for butt-joint having an X-shape groove is performed (S110) on the condition that the parent metals are 50 mm thick, a front side groove angle is 40 degrees, a rear side groove angle is 50 degrees, a root gap between the metals is 0 mm, and the front side and the rear side have a half thickness of the parent metal. A first pass of welding is performed using the FCAW having a low welding heat input in order to prevent generation of a burn-through (S120). Next, by performing 6 passes of the SAW having a higher deposition rate than the FCAW, welding of the front sides is completed totally through 7 passes (S130).

The parent metals thus completed with welding of the front sides are turned over (S140), and gouging and grinding are performed (S150) to prevent LF. Next, the SAW is performed by 7 passes, thereby completing the overall welding (S160).

FIG. 2 shows the one-side welding performed (S210) for parent metals with a V-shape groove, the parent metals of which thickness is 48 mm, a groove angle is 40 degrees, a root gap is 6 mm. A backing material 22 is attached to the rear sides of the parent metals to prevent the burn-through during the initial welding. The FCAW is performed by 2 passes (S220). Next, the SAW is performed by 15 passes, thereby completing the welding (S230).

During the SAW, one layer can be welded by one pass at the beginning where the width of groove of the parent metal is relatively narrow. However, as the welding processes advance, because the groove width is increased, just one pass is insufficient in welding one layer. That is, at least 2 passes of welding need to be performed per one layer. Thus, the number of welding processes would be abruptly increased.

As described above, when welding a 50 mm thick parent metal by the both-sides welding and a 48 mm thick parent metal by the one-side welding, about 13 to 15 passes of SAW are repeated in total. Thus, the welding productivity is very poor.

### SUMMARY OF THE INVENTION

Therefore, the present invention has been made in view of the above problems, and it is an object of the present invention to provide a butt-joint welding method, capable of improving the welding efficiency by reducing the number of welding passes, that is, by attaching a backing material to rear sides of parent metals, performing flux cored arc welding (FCAW) or compositely performing the FCAW and submerged arc welding (SAW) 1-3 times between the two parent metals, and transversely weaving a SAW wire having a diameter of at least 3.2 mm at 45-90 degrees with regard to a welding direction, using a composite wire which is a high-efficiency wire having a high deposition rate according to thickness of the parent metal, and also using a supplemental wire to enhance the deposition rate such that the butt-joint welding be achieved by once of SAW.

It is another object of the present invention to provide a method of butt-welded joint capable of considerably reducing the number of welding passes, when welding a thick parent metal having 30-100 mm thickness, by weaving a SAW wire having at least 3.2 mm diameter so that welding of one layer can be completed by one pass in spite of increase of a groove width, and also capable of improving the welding efficiency by reducing the number of the SAW passes by using a supplemental wire and a composite wire having a higher deposition rate than a general solid wire.

In accordance with the present invention, the above and other objects can be accomplished by the provision of a butt-joint welding method comprising arranging two parent metals having 10-35 mm thickness at an interval of 8-20 mm to face each other, attaching a backing material to rear sides of the two parent metals, the rear sides facing each other, so that the backing material seals a space between the parent metals through surface-contact with the rear sides, performing flux cored arc welding (FCAW) or compositely performing the FCAW and submerged arc welding (SAW) 1-3 times on an upper layer of the backing material, generating an arc by applying predetermined voltage and current to a SAW wire and welding the two parent metals to melt the welding wire by the arc heat while weaving the SAW wire at an angle of 45-90 degrees with respect to a welding direction. Here, a composite wire and a supplemental wire may be solely or compositely applied according to thickness of the parent metals.

To perform welding by the above welding method, it is preferred that the parent metals are 10-35 mm thick, the root gap is 8-20 mm, diameters of the solid wire and the composite wire are 3.2-5.0 mm, a diameter of the supplemental wire is 1.0-2.4 mm, a weaving angle of the welding wire with respect to the welding direction is 45-90 degrees, a weaving width is 5-30 mm, and a weaving frequency is 20-90 times per minute.

A butt-joint welding method with parent metals forming an X-shape groove and having 30-100 mm thickness, the welding method comprises arranging the two parent metals to form the X-shape groove (S410), performing a first pass of welding using the FCAW having a relatively low deposition rate for prevention of a burn-through (S420), supplying a supplemental wire in the groove face and performing the SAW several times while weaving a welding wire, thereby completing welding of front sides (S430), turning over the parent metals welded on the front sides (S440), and supplying a supplemental wire in the other groove face and performing the SAW several times while weaving a welding wire, thereby completing welding of rear sides (S450).

A butt-joint welding method with parent metals with 30-100 mm thickness and a Y-shape groove, the welding method comprises arranging the parent metals to form the Y-shape groove (S510), supplying a supplemental wire in the groove face and performing the SAW several times while weaving a welding wire, thereby completing welding of front sides (S520), turning over the parent metals welded on the front sides (S530), and performing the SAW by 1 pass, thereby completing welding of rear sides (S540).

In addition, a butt-joint welding method with parent metals with 30-100 mm thickness and a V-shape groove, the welding method comprises arranging the two parent metals to form a V-shape groove (S610), attaching a backing material to rear sides of the parent metals facing each other to seal a space between the parent metals through surface-contact (S620), performing the FCAW by 2 passes to an upper layer of the space sealed by the backing material (S630), and supplying a supplemental wire in the groove face and performing the SAW several times while weaving the welding wire, thereby completing the overall welding (S640).

When performing butt-joint welding to the parent metals of 30-100 mm as above, it is preferred that the root gap between the parent metals is 0-10 mm, the solid wire and the composite wire have 3.2-5.0 mm diameter, the supplemental wire comprises a cut wire or a rod wire, and the welding wire is weaved by the weaving width of 10-30 mm and the weaving frequency of 20-100 times/min.

### BRIEF DESCRIPTION OF THE DRAWINGS

The above and other objects, features and other advantages of the present invention will be more clearly understood from the following detailed description taken in conjunction with the accompanying drawings, in which:

FIG. 1 illustrates processes of a conventional both-sides welding;

FIG. 2 illustrates processes of a conventional one-side welding;

FIG. 3 illustrates welding processes according to an embodiment of the present invention;

FIG. 4 illustrates welding processes with an X-shape groove according to a second embodiment of the present invention;

FIG. 5 illustrates welding processes with a Y-shape groove according to the second embodiment of the present invention;

FIG. 6 illustrates welding processes with a V-shape groove according to the second embodiment of the present invention;

FIGS. 7a and 7b illustrate a sectional appearance of weld metal for Comparative example 1 and a first embodiment of the present invention, respectively;

FIGS. 8a-8d illustrate a sectional appearance of weld metal according to a first, second, third and fourth embodiment of the present invention, respectively;

FIGS. 9a and 9b illustrate a sectional appearance of weld metal for Comparative example 2 and a second embodiment of the present invention, respectively; and

FIGS. 10a and 10b illustrate a sectional appearance of weld metal for Comparative example 3 and a second embodiment of the present invention, respectively.

### DETAILED DESCRIPTION OF THE PREFERRED EMBODIMENTS

Hereinafter, an exemplary embodiment of the present invention will be described in detail with reference to the accompanying drawings.

FIG. 3 illustrates welding processes according to an embodiment of the present invention. Objects to be welded, that is, parent metals 21 are properly arranged for butt-joint welding. A backing material 22 is attached to rear sides of the parent metals 21 facing each other to prevent a burn-through from the metal being welded (S310).

At least one or more out of homogeneous metal with the parent metal, copper, heat-resistant material, and ceramic are used for the backing material 22. The backing material 22 has a groove or is flat.

At a space between the facing parent metals 21 sealed by the backing material 22, twice of a flux cored arc welding (FCAW) is generally performed (S320). However, in accordance with the root gap and the thickness of the parent metals 21, the FCAW may be performed 1-3 times or the FCAW and a submerged arc welding (SAW) may be compositely performed.

After a supplemental wire 23 is applied to the space among an upper part of the weld metal and the facing parent metals in order to increase a deposition rate, a SAW flux 25 is applied on the supplemental wire 23 (S330). In the applied SAW flux 25, an arc is generated between a leading end of a welding wire 24 and the parent metals. The welding wire 24 is continuously supplied while being weaved at 45-90 degrees with respect to a welding direction. Thus, the one-side welding is completed (S340).

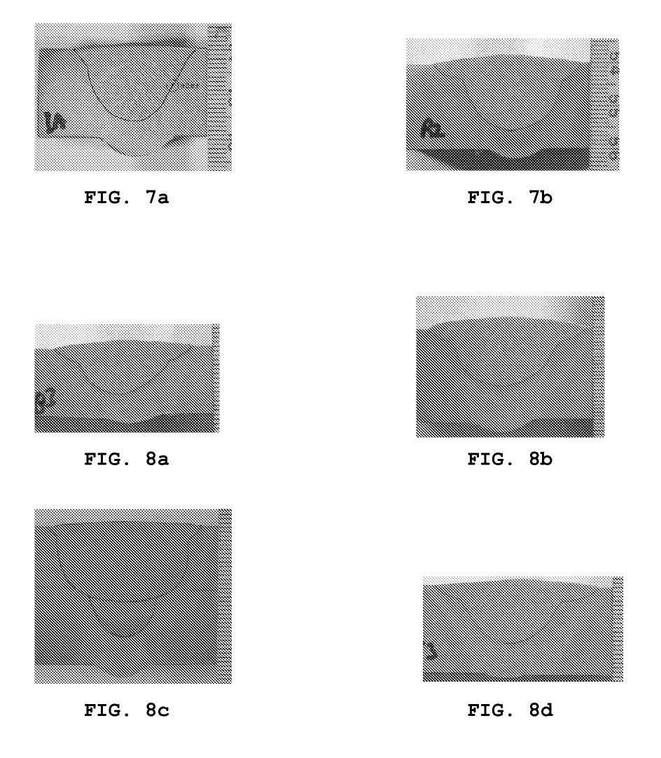

Below, the embodiment of the present invention is tabulated in (Table 1). Sectional appearances of weld metal corresponding to the Comparative example 1 and the 1^{st} embodiment are shown in FIGS. 7a and 7b, respectively.

TABLE 1

| Method | Features |
|---|---|
| Comparative | Metal thickness: 20 mm |
| example 1 | Root gap: 12 mm |
| (conventional | Completion: FCAW 2 passes + |
| art) | SAW 2 passes |
| | supplemental wire used |
| | Composite wire of 4.8 mm |
| | diameter |
| | LF generated in weld metal |
| 1^{ST} embodiment | Metal thickness: 20 mm |
| (present | Root gap: 12 mm |
| invention) | Completion: FCAW 2 pass + |
| | SAW 1 pass + weaving SAW 1 |
| | pass |
| | Weaving width 10 mm, weaving |
| | frequency 28 times/min |
| | supplemental wire used |
| | Composite wire of 4.8 mm |
| | diameter |
| | No LF in weld metal, weld |
| | metal wider than in |
| | conventional art |

On the condition that the parent metals are 20 mm thick and the root gap is 12 mm, the one-side welding is compared between the embodiment of the present invention and the conventional art. A backing material is attached to rear sides of the parent metals, and twice of the FCAW and once of the SAW are performed. After that, a supplemental wire is applied to an upper layer of the welded portion. A composite wire is used as a welding wire.

In the comparative example of the conventional art, the welding is completed by one time without performing weaving of the welding wire. Meanwhile, according to the embodiment of the present invention, the welding wire is weaved by the weaving width of 10 mm and the weaving frequency of 28 times/min, thus completing the welding by one time.

As shown in the comparative example of (Table 1), an LF having 0.5 mm width and 2 mm length is generated at an edge of the weld metal. The LF is generated as the welding wire deviates from the precise center of the space between the two parent metals. Comparing the size of the weld metal between the conventional art and the present invention, the weld metal of the conventional art has 27.1 mm width at a surface thereof and 15.7 mm width at a half-thickness position. The weld metal of the embodiment of the present invention applying the weaving SAW, has 31.6 mm and 19.5 mm width at the surface and at the half-thickness position, respectively, without any LF generated. That is, because the width of the weld metal is increased by 4.5 mm and 3.8 mm, the LF of 0.5 mm size generated in the conventional art cannot appear in the present invention. In other words, the width of the weld metal is increased by weaving the SAW wire by 10 mm width, thereby removing the LF at the welded portion.

TABLE 2

| Embodi- | | |
|---|---|---|
| ment | Method | Features |
| 1 | FCAW 2 passes + | Metal thickness: |
| | weaving | 15 mm, |
| | SAW(solid wire) | Root gap: 8 mm |
| | 1 pass | Weaving width 10 mm, |
| | | frequency 47 times/min |
| | | supplemental wire not |
| | | used, solid wire used |
| 2 | FCAW 2 passes + | metal thickness: 25 mm, |
| | weaving | Root gap: 18 mm |
| | SAW(composite | Weaving width 20 mm, |
| | wire) 1 pass | frequency 27 times/min |
| | | supplemental wire |
| | | used, composite wire |
| | | used |
| 3 | FCAW 2 passes + | metal thickness: 32 mm, |
| | SAW 1 pass + | Root gap: 12 mm |
| | weaving | Weaving width 15 mm, |
| | SAW(composite | frequency 50 times/min |
| | wire) 1 pass | supplemental wire |
| | | used, composite wire |
| | | used |
| 4 | FCAW 2 passes + | metal thickness: 20 mm, |
| | weaving | Root gap: 8 mm |
| | SAW(solid wire) | Weaving width 10 mm, |
| | 1 pass | frequency 80 times/min |
| | | supplemental wire |
| | | used, solid wire used |

(Table 2) above and FIGS. 8a-8d show the effect of the embodiments of the present invention applying weaving of the welding wire. With regard to (Table 2, FIG. 8a corresponds to embodiment 1, FIG. 8b corresponds to embodiment 2, FIG. 8c corresponds to embodiment 3, and FIG. 8d corresponds to embodiment 4. More specifically, in the embodiment 1, the FCAW is performed twice with the parent metals of 15 mm thickness and the root gap of 8 mm, and the SAW is next performed while weaving a welding wire, that is, a solid wire having 4.8 mm diameter by the weaving width of 10 mm and the weaving frequency of 47 times/min. No LF is generated at the sectional surface of the weld metal.

In the embodiment 2, the FCAW is performed twice and the SAW once with the parent metals of 25 mm thickness and the root gap of 18 mm. In addition, the weaving SAW is performed once using a composite wire of 4.8 mm diameter by the weaving width of 20 mm and the weaving frequency of 27 times/min. The LF does not occur at the sectional surface of the weld metal.

In the embodiment 3, the FCAW is performed twice and the SAW once with the parent metals of 32 mm thickness and the root gap of 12 mm. In addition, the weaving SAW is performed once by the weaving width of 15 mm and the weaving frequency of 50 times/min. The LF does not occur at the sectional surface of the weld metal.

In the embodiment 4, the FCAW is performed twice with the parent metals of 20 mm thickness and the root gap of 8 mm. In addition, the weaving SAW is performed once by the weaving width of 10 mm and the weaving frequency of 80 times/min. The LF does not occur at the sectional surface of the weld metal.

Hereinafter, a butt-joint welding method according to the second embodiment of the present invention will be described in detail with reference to the drawings.

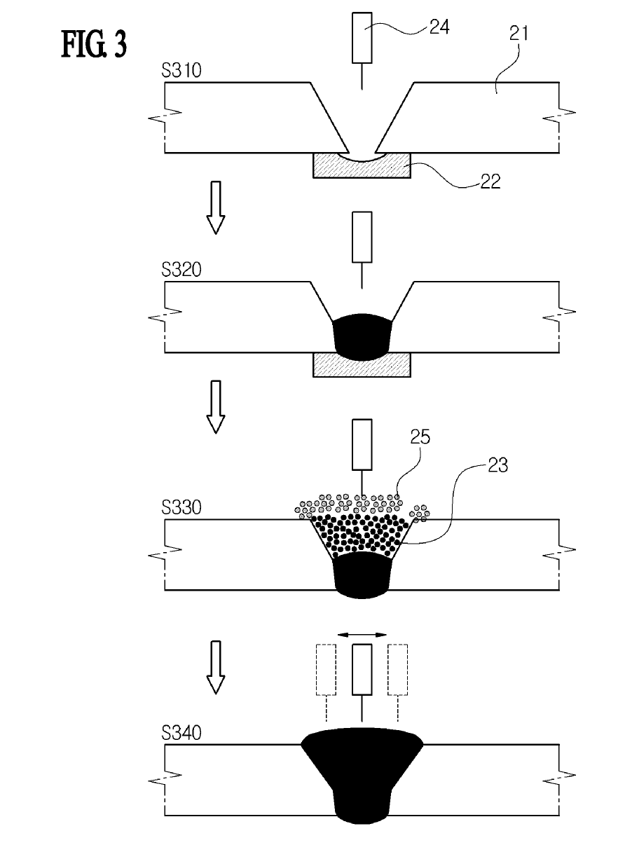

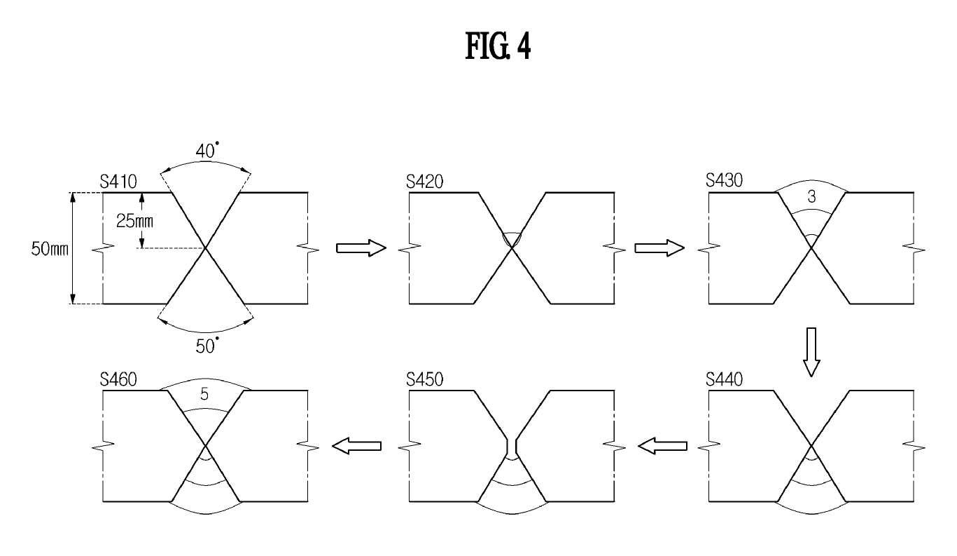

FIG. 4 through FIG. 6 are showing the processes of the welding method according to the second embodiment of the present invention. In FIG. 4, two parent metals having an X-shape groove and 50 mm thickness are welded by butt-joint welding (S410). The first pass of welding is performed using the FCAW having a relatively low deposition rate for prevention of a burn-through (S420). A supplemental wire is supplied in the groove face and the SAW is performed by 2 passes while weaving a welding wire, thereby completing welding of front sides (S430). The parent metals welded on the front sides are turned over (S440). A supplemental wire is supplied in the other groove face and the SAW is performed by 2 passes while weaving a welding wire, thereby completing welding of rear sides (S450).

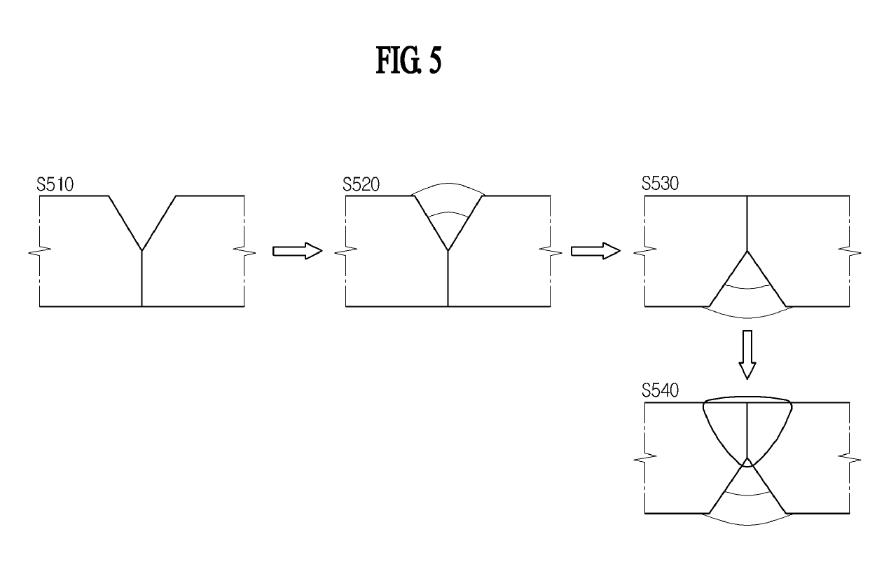

Referring to FIG. 5, two parent metals having a Y-shape groove and 40 mm thickness are welded by butt-joint welding (S510). A supplemental wire is supplied in the groove face and the SAW is performed by 2 passes while weaving a welding wire, thereby completing welding of front sides (S520). The parent metals welded on the front sides are turned over (S530). The SAW is performed by 1 pass, thereby completing welding of rear sides (S540). Here, before welding the rear sides, gouging and grinding may be additionally performed in order to prevent the LF from generating at the initial FCAW-welded layer.

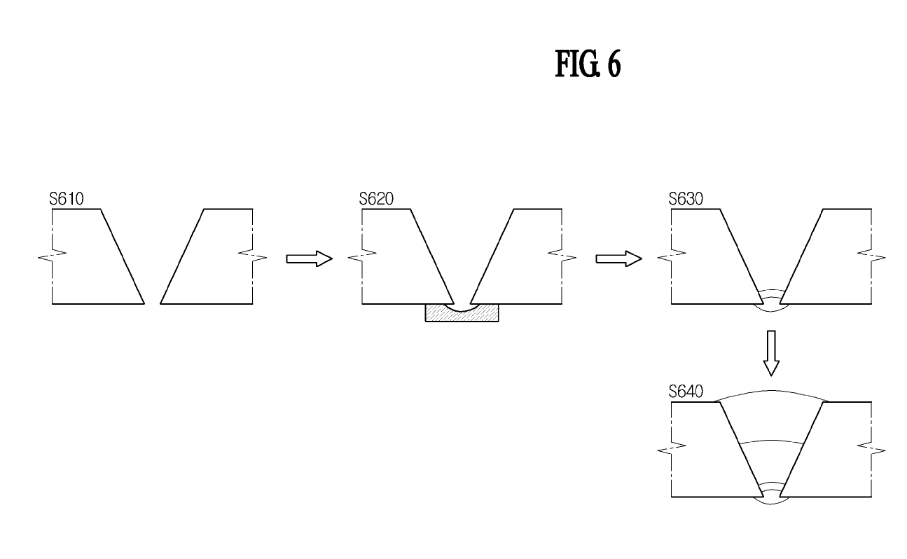

Referring to FIG. 6, two parent metals having a V-shape groove and 50 mm thickness are welded by butt-joint welding (S610). A backing material is attached to establish surface-contact with the rear sides of the parent metals facing each other (S620). The FCAW is performed by 2 passes to an upper layer in a space sealed by the backing material between the parent metals (S630). A supplemental wire is supplied in the groove face and the SAW is performed by 2 passes while weaving the welding wire, thereby completing the overall welding (S640) .

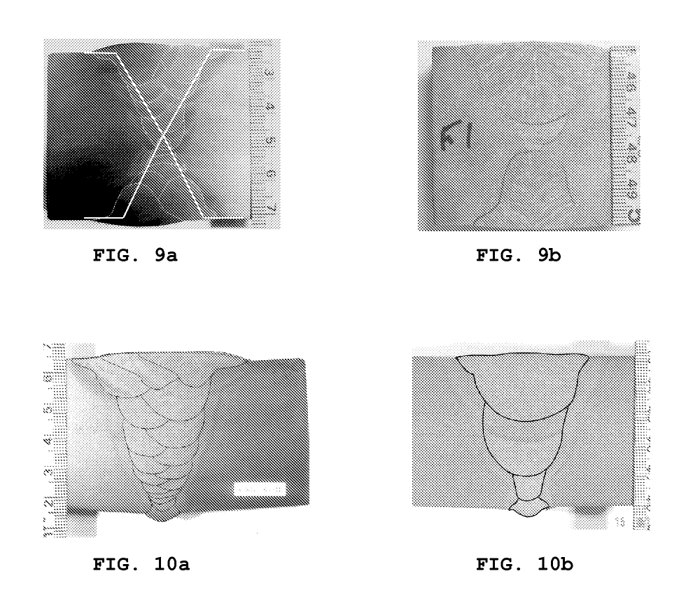

Hereinafter, the second embodiment of the present invention will be described in detail with reference to (Table 3) and (Table 4) as below, as well as FIGS. 9a, 9b, 10a and 10b.

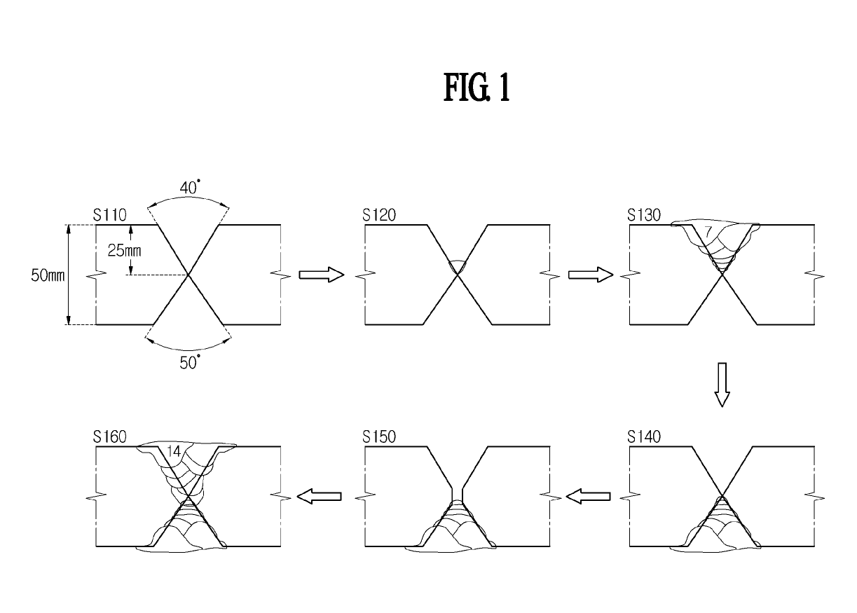

TABLE 3

| Method | Features |
|---|---|
| Comparative | Metal thickness: 50 mm |
| example 2 | Root gap: 0 mm |
| (conventional | Thickness of front weld |
| art: FIG. 1) | metal: 25 mm |
| | Completion: FCAW 1 pass + |
| | SAW 13 passes |
| | supplemental wire not used |
| | Solid wire of 4.8 mm |
| | diameter |
| 2^{nd} embodiment | Metal thickness: 50 mm |
| (present | Root gap: 0 mm |
| invention) | Thickness of front weld |
| | metal: 33 mm |
| | Completion: FCAW 1 pass + |
| | SAW 3 passes |
| | supplemental wire used |
| | Solid wire of 4.8 mm |
| | diameter |
| | Weaving: SAW in 2^{nd} pass |
| | and 3^{rd} pass |
| | Weaving width 15 mm, |
| | frequency 50 times/min |

In (Table 3) as above, as well as FIGS. 9a and 9b, the sectional appearance of the X-shape groove in the parent metals having 50 mm thickness is compared between the second embodiment of the present invention and the conventional art. With respect to (Table 3) FIG. 9a corresponds to Comparative example 2 and FIG. 9b corresponds to the 2^{nd} embodiment. The FCAW is performed for the first welding process to prevent the burn-through. Next, the SAW having a higher deposition rate than the FCAW is performed in filling in a remaining portion.

In the comparative example 2 according to the conventional art, the application of the supplemental wire and weaving of the welding wire are not performed. On the other hand, the second embodiment performs the SAW while using the supplemental wire in second and third passes of the SAW and weaving the welding wire by the weaving width of 15 mm and the weaving frequency of 50 times/min.

As shown in (Table 3), as well as FIGS. 9a and 9b, 13 passes of the SAW are performed to complete the welding in the comparative example 2. However, according to the second embodiment of the present invention, the parent metals of 50 mm thickness are completely welded through 3 passes of the SAW.

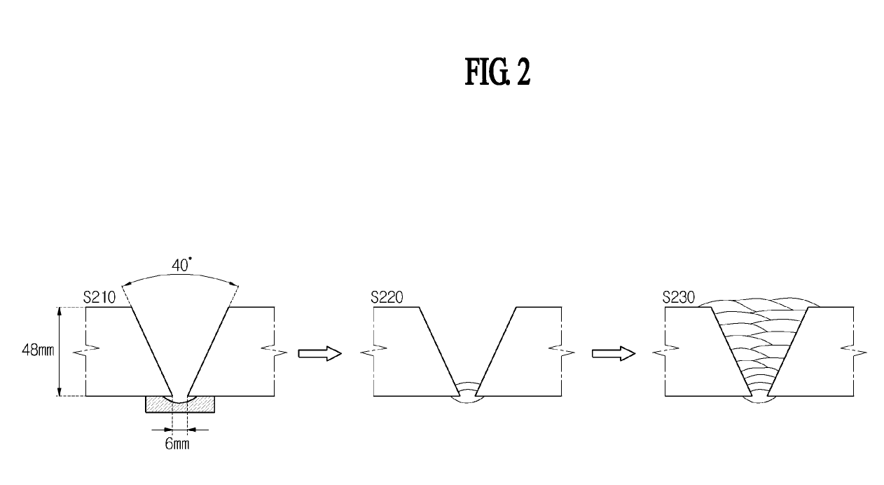

TABLE 4

| Method | Features |
|---|---|
| Comparative | Metal thickness: 48 mm |
| example 3 | Root gap: 6 mm |
| (conventional | Completion: FCAW 2 |
| art: FIG. 2) | passes + SAW 15 passes |
| | supplemental wire not |
| | used |
| | Solid wire of 4.8 mm |
| | diameter |
| 2^{nd} embodiment | Metal thickness: 50 mm |
| (present | Root gap: 6 mm |
| invention) | Completion: FCAW 2 |
| | passes + SAW 2 passes |
| | supplemental wire used |
| | Composite wire of 4.8 mm |
| | diameter |
| | Weaving: SAW in 2 pass |
| | Weaving width 20 mm, |
| | frequency 30 times/min |

In (Table 4), as well as FIGS. 10a and 10b, the sectional appearance of the V-shape groove in the parent metals having thicknesses of 48 mm and 50 mm is compared between the conventional art and the second embodiment of the present invention. The parent metals are distanced by the root gap of 6 mm, and a backing material is attached to the rear sides to prevent generation of a burn-through. The FCAW having the lower deposition rate is performed by 2 passes on the backing material. Next, the SAW is performed to fill in a remaining portion. With respect to (Table 4) FIG. 10a corresponds to Comparative example 3 and FIG. 10b corresponds to the 2^{nd} embodiment.

In the comparative example 3 according to the conventional art, the welding is performed without neither applying the supplemental wire nor weaving the welding wire. On the other hand, the second embodiment performs the SAW welding by 2 passes by using the supplemental wire and weaving the welding wire by the weaving width of 20 mm and the weaving frequency of 30 times/min.

As shown in (Table 4), as well as FIGS. 10a and 10b, while 15 passes of the SAW are performed to complete the welding in the comparative example 2, the parent metals of 50 mm thickness can be completely welded through 2 passes of the SAW according to the second embodiment of the present invention.

TABLE 5

| Embodiment | 5 | 6 | 7 |
|---|---|---|---|
| Metal thickness | 46 mm | 76 mm | 40 mm |
| Groove | Y-shape | X-shape | V-shape |
| Completion | SAW 3 passes | FCAW 1 pass + | FCAW 2 passes + |
| | | SAW 5 passes | SAW 3 passes |
| Weaving | SAW 2^{nd} pass | SAW 4^{th}, 5^{th} | SAW all passes |
| | | passes | |
| Weaving width | 15 mm | 19 mm | 10 mm |
| Weaving | 47 times/min | 47 times/min | 90 times/min |
| frequency | | | |
| supplemental | SAW 2^{nd} pass | SAW all passes | SAW 2^{nd}, 3^{rd} |
| wire | | | passes |
| Welding wire | Composite wire | Solid wire | Solid wire |

(Table 5) as above explains the effect of the embodiments of the present invention applying weaving of the welding wire. More specifically, in the embodiment 5, two parent metals with a Y-shape groove, 46 mm thickness and the root gap of 0 mm are welded by butt-joint welding. A composite wire having 4.8 mm diameter is weaved by the weaving width of 15 mm and the weaving frequency of 47 times/min, while using a welding filler in the second pass of the SAW. The overall welding is completed by 3 passes of the SAW. No LF is generated at the sectional surface of the weld metal.

In the embodiment 6, two parent metals with an X-shape groove, 76 mm thickness and the root gap of 0 mm are welded by butt-joint welding. While performing 1 pass of the FCAW and 5 passes of the SAW until completion of the welding, a supplemental wire is used and a solid wire having 4.8 mm diameter is weaved in the fourth and the fifth passes by the weaving width of 19 mm and the weaving frequency of 47 times/min. No LF is generated at the sectional surface of the welded portion.

In the embodiment 7, two parent metals with a V-shape groove, 40 mm thickness and the root gap of 10 mm are welded by butt-joint welding. While performing 2 passes of the FCAW and 3 passes of the SAW until completion of the welding, a supplemental wire is used during the SAW and a solid wire having 4.0 mm diameter is weaved by the weaving width of 19 mm and the weaving frequency of 90 times/min. No LF is generated at the sectional surface of the weld metal.

As apparent from the above description, the present invention provides a butt-joint welding method with parent metals having a large root gap, capable of obtaining a high-quality welded product without a lack of fusion (LF) by weaving a SAW wire having at least 3.2 mm diameter and completing the welding with once or twice of the SAW. Also, the productivity can be improved by reducing the number of welding passes. In addition, when performing the SAW for butt-joint welding with parent metals of 30-100 mm thickness, since one-layer one-pass welding can be accomplished by weaving the SAW wire, the number of welding passes is saved, accordingly improving the productivity.

Although the preferred embodiments of the present invention have been disclosed for illustrative purposes, those skilled in the art will appreciate that various modifications, additions and substitutions are possible, without departing from the scope and spirit of the invention as disclosed in the accompanying claims.

What is claimed is:

1. A butt-joint welding method comprising:
arranging two parent metals having 10-35 mm thickness at an interval of 8-20 mm to face each other;
attaching a backing material to rear sides of the two parent metals, the rear sides facing each other, so that the backing material seals a space between the parent metals through surface-contact with the rear sides;
performing flux cored arc welding or compositely performing the flux cored arc welding and submerged arc welding 1-3 times on an upper layer of the backing material; and
welding the two parent metals while weaving a submerged arc welding wire transversely.

2. The welding method according to claim 1, wherein the submerged arc welding wire comprises a solid wire or a composite wire having 3.2-5.0 mm diameter.

3. The welding method according to claim 1, wherein a supplemental wire filled in the space between the two parent metals has 1.0-2.4 mm diameter.

4. The welding method according to claim 1, wherein a weaving angle of the welding wire is 45-90 degrees with respect to a welding direction, a weaving width is 5-30 mm, and a weaving frequency is 20-90 times/min.

5. A butt-joint welding method, comprising:
arranging two parent metals having 30-100 mm thickness to form a groove having any one of X, Y and V shapes; and
performing submerged arc welding of the two parent metals while weaving a submerged arc welding wire of 3.2-5.0 mm diameter.

6. The welding method according to claim 5, wherein the submerged arc welding wire comprises a solid wire or a composite wire.

7. The welding method according to claim 5, wherein the welding wire is weaved by a weaving width of 10-30 mm and a weaving frequency of 20-100 times/min.

8. The welding method according to claim 5, wherein a supplemental wire supplied to a space between the two parent metals comprises a cut wire or a rod wire.
